(19) United States
(12) Patent Application Publication
(10) Pub. No.: US 2015/0242788 A1
(43) Pub. Date: Aug. 27, 2015

(54) SYSTEMS, METHODS, AND NON-TRANSITORY COMPUTER-READABLE MEDIUMS THAT PROVIDE FOR PARTITIONING OF AN ORIGINAL GEOGRAPHIC AREA INTO MULTIPLE GEOGRAPHIC SEED AREAS AS PART OF BALANCING A BUSINESS-RELATED WORKLOAD

(71) Applicants: Wei Wu-Emmert, Collierville, TN (US); Tyrell J. Fowler, Collierville, TN (US); Frederick A. DeZemplen, IV, Collierville, TN (US)

(72) Inventors: Wei Wu-Emmert, Collierville, TN (US); Tyrell J. Fowler, Collierville, TN (US); Frederick A. DeZemplen, IV, Collierville, TN (US)

(21) Appl. No.: 14/189,054

(22) Filed: Feb. 25, 2014

(51) Int. Cl. G06Q 10/06

(52) U.S. Cl. CPC G06Q 10/06316

(57) ABSTRACT

A method is described for partitioning an original geographic area into smaller logical geographic seed areas as part of balancing a business-related workload. A computer system generates a plurality of data structures in a memory respectively representing the plurality of logical geographic seed areas based upon a watershed analysis of transport-related burden information within the original geographic area and transport-related flow information within the original geographic area. Each data structure includes a first element identifying the logical geographic seed areas and a second data element identifying a seed point. The computer system then determines if the business-related workload for each of the logical geographic seed areas is substantially balanced based upon the at least one business-related metric. If there is an imbalance, the computer system transforms at least one of the data structures to effectively partition one of the seed areas into smaller subdivisions represented with alternative data structures.

### FIELD OF THE DISCLOSURE

The present disclosure relates to systems, apparatus, articles of manufacture (such as a non-transitory computer readable medium) and methods in the field of territory partitioning and, more particularly, in the field of partitioning a larger geographic area into smaller geographic seed areas as part of balancing a business-related workload.

### BACKGROUND

In many businesses, a continuing problem persists related to how a business associates or deals with a particular region of geography. More particularly, many businesses commonly need to determine how to generate an appropriate measure for geographic area to describe a division of work.

Postal Codes are known to provide a manner of dividing a larger geographic area into smaller areas. Some or many developed countries tend to approach this issue by creating geographic subdivisions to assign a name or code that represents the smaller area, thereby assigning addresses and making it easier to sort and deliver as well as to collect mail and packages. One existing approach to this issue may deploy simple trial and error techniques to alter the defined boundaries of such subdivisions.

Even if automated to break up, known methodologies often do so without the proper context and provide results that often frustrate one or more business purposes in the process. For example, common automated processes that may break up a given geographic area provide the basis for business routes (e.g., delivery or pickup) that cross or be objectionable to those involved in the business route (e.g., drivers).

Thus, there remains a need for an intelligent manner of partitioning an original geographic area into a plurality of logical geographic seed areas as part of balancing a business-related workload.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

In one aspect, a computer-implemented method is described for partitioning an original geographic area into a plurality of logical geographic seed areas as part of balancing a business-related workload. The method begins with the computer system generating a plurality of data structures in a memory. The data structures respectively represent the logical geographic seed areas based upon a watershed analysis of both transport-related burden information within the original geographic area and transport-related flow information within the original geographic area. Each of the data structures generated has a first data element identifying one of the logical geographic seed areas and a second data element identifying one of a plurality of seed points corresponding to a transport interface for the respective one of the logical geographic seed areas.

The method then has the computer system accessing at least one set of business-related metric information for each of the logical geographic seed areas, where the set of business-related metric information is maintained on a memory storage operatively coupled to the computer system. The method then has the computer system determining if the business-related workload for each of the logical geographic seed areas is substantially balanced based upon the at least one business-related metric. The method generally concludes with the computer system transforming at least one of the data structures representing one of the logical geographic seed areas into at least two alternative data structures respectively representing a subdivision of the one of the logical geographic seed areas when the at least one business-related metric reflects an imbalance in the business-related workload for the one of the logical geographic seed areas.

In another aspect, a non-transitory computer-readable medium is described that contains instructions, which when executed on a processor, performs a method for partitioning an original geographic area into a plurality of logical geographic seed areas as part of balancing a business-related workload, such as discussed above.

In yet another aspect, a computer system is described for partitioning an original geographic area into a plurality of logical geographic seed areas as part of balancing a business-related workload. The computer system comprises at least one processing unit and at least one memory storage coupled to the processing unit. The memory storage maintains at least GIS code and partitioning code for execution by the processing unit. Additionally, the memory storage maintains at least one set of business-related metric information.

When the processing unit of the computer system executes the GIS code maintained on the memory storage, the processing unit is configured and, thus, specially adapted to be operative to access GIS data representing the original geographic area.

And when processing unit of the computer system executes the partitioning code maintained on the memory storage, the processing unit is configured and, thus, specially adapted to be operative to assemble transport-related burden information associated with the original geographic area, and determine transport-related flow information associated with the original geographic area where the transport-related flow information is related to the assembled transport-related burden information. Furthermore, the processing unit is operative to generate and store a plurality of data structures in the memory storage, where the data structures respectively represent the plurality of logical geographic seed areas based upon a watershed analysis of the transport-related burden information within the original geographic area and the transport-related flow information within the original geographic area. Each of the data structures generated comprises a first data element identifying one of the logical geographic seed areas and a second data element identifying one of a plurality of seed points corresponding to a transport interface for the respective one of the logical geographic seed areas.

The processing unit is then operative to access at least one set of business-related metric information maintained within the memory storage, and determine if the business-related workload for each of the logical geographic seed areas is substantially balanced based upon the accessed at least one business-related metric. When the business-related metric reflects an imbalance in the business-related workload for the one of the logical geographic seed areas, the processing unit is also operative to transform at least one of the data structures representing one of the logical geographic seed areas into at least two alternative data structures respectively representing a subdivision of the one of the logical geographic seed areas, and then store the alternative data structures within the memory storage.

Additional advantages of this and other aspects of the disclosed embodiments and examples will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments according to one or more principles of the invention and together with the description, serve to explain one or more principles of the invention. In the drawings,

FIG. 1 is a diagram of an exemplary computer system deployed in a sample networked operating environment in accordance with an embodiment of the invention;

FIG. 2 is a more detailed diagram illustrating exemplary hardware and software components in the exemplary computer system of FIG. 1;

FIG. 3 is an diagram of an exemplary original geographic area in accordance with an embodiment of the invention;

FIG. 4 is an diagram of the exemplary geographic area partitioned into an exemplary grid of units in accordance with an embodiment of the invention;

FIG. 5 is an diagram of exemplary sets of different types of exemplary transport-related burden data that collectively make up a composite transport-related burden value for each of the units in accordance with an embodiment of the invention;

FIG. 6 is an diagram illustrating exemplary transport-related flow information for the exemplary geographic area in accordance with an embodiment of the invention;

FIG. 7 is an diagram of the exemplary geographic area separated into an exemplary group of logical geographic seed areas in accordance with an embodiment of the invention;

FIG. 8 is an diagram illustrating one of the exemplary logical geographic seed areas transformed into a division of the seed area in accordance with an embodiment of the invention;

FIG. 9 is a flowchart diagram illustrating exemplary steps of a method for partitioning the original geographic area into a plurality of logical geographic seed areas as part of balancing a business-related workload in accordance with an embodiment of the invention; and

FIG. 10 is a more detailed flowchart diagram illustrating exemplary steps for partitioning the original geographic area in accordance with an embodiment of the invention.

### DESCRIPTION OF THE EMBODIMENTS

Reference will now be made in detail to exemplary embodiments. Wherever possible, the same reference numbers are used in the drawings and the description to refer to the same or like parts.

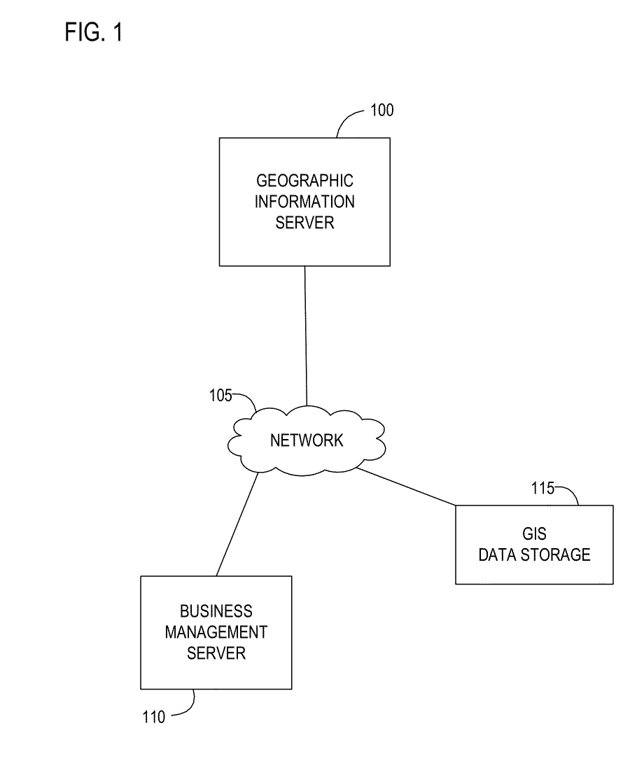

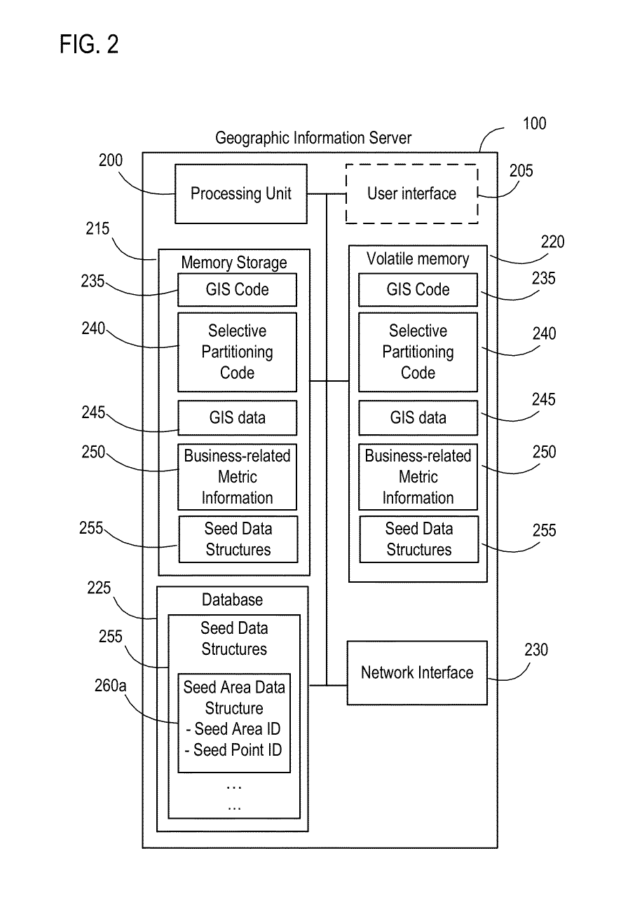

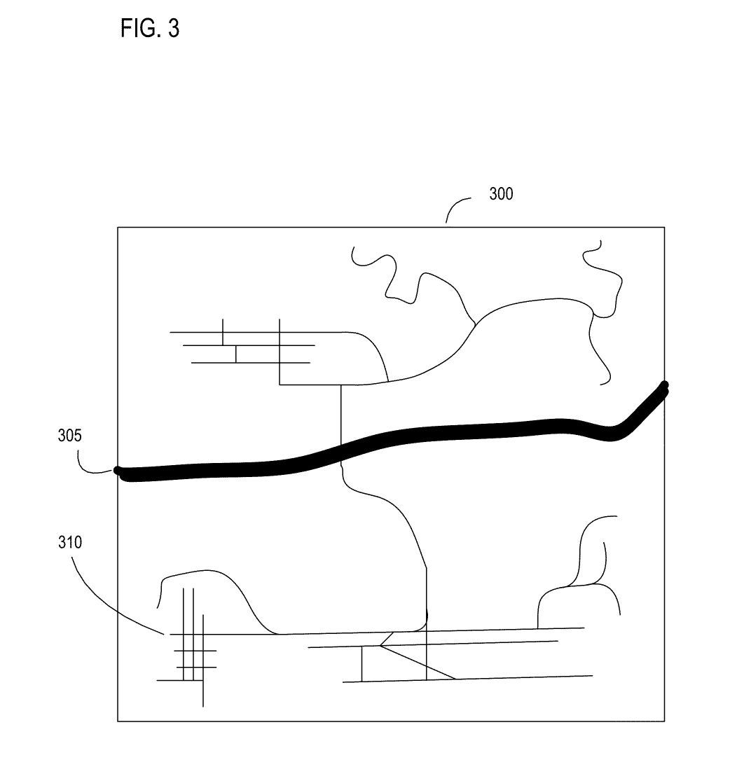

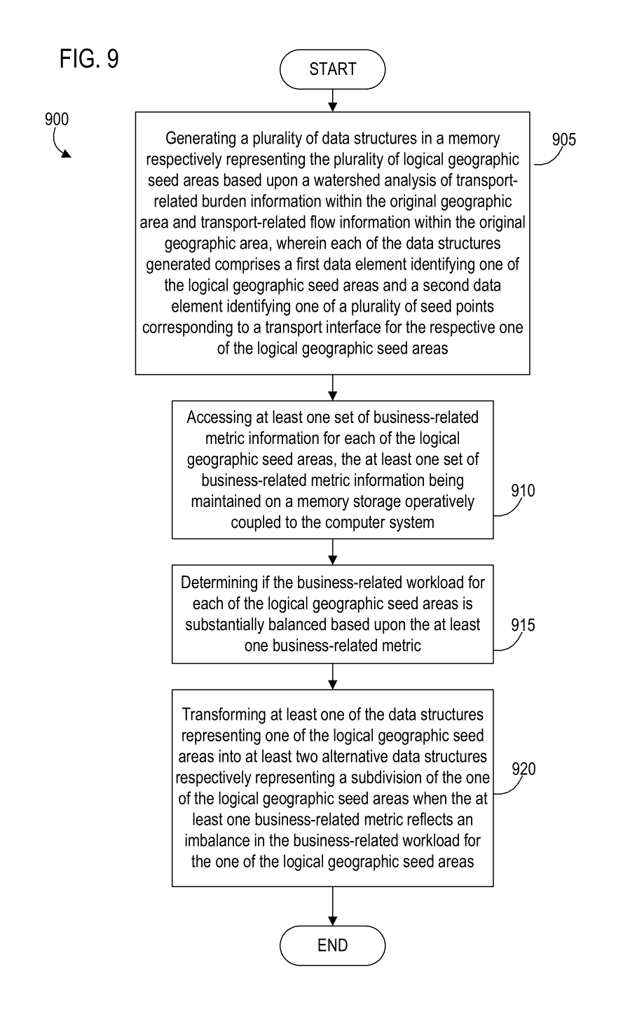

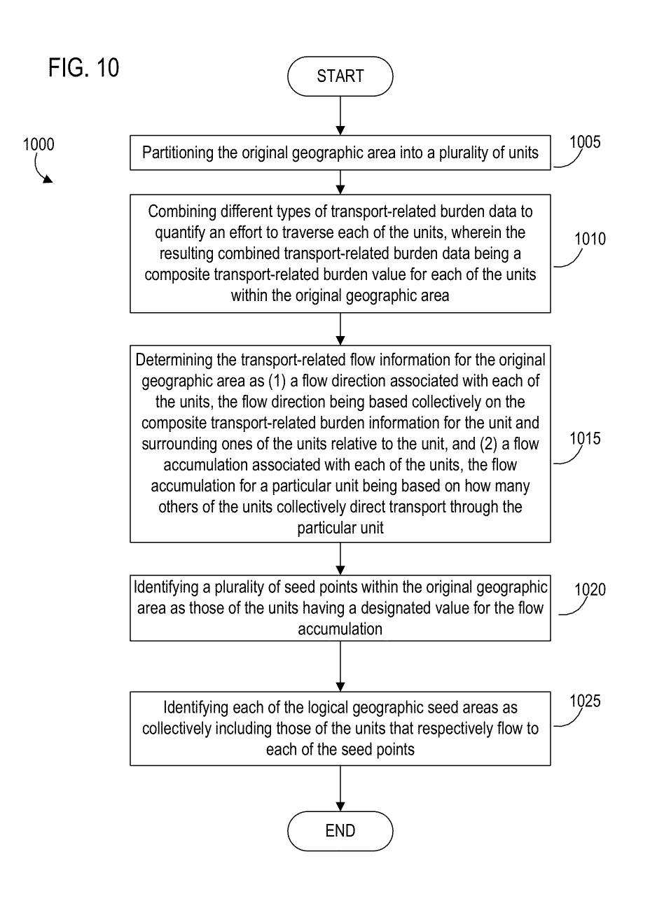

In summary, the following describes various exemplary embodiments of a system, method, and non-transitory computer-readable medium that provides the ability to partition an original geographic area into a plurality of logical geographic seed areas as part of balancing a business-related workload within the geographic area as set forth herein. FIGS. 1 and 2 provide details on an exemplary operating environment, which includes an exemplary computer system having servers, non-transitory computer-readable medium, and particular exemplary hardware and software modules in embodiments of the invention. In context of this exemplary operating environment, FIGS. 3-8 are general illustrative diagrams showing how the original geographic area may be transformed into smaller seed areas and represented by data structures in accordance with embodiments of the invention. And, FIGS. 9-10 are flowcharts describing steps in an exemplary method for partitioning the original geographic area into the logical geographic seed areas as part of balancing a business-related workload.

As will be described in more detailed below, an embodiment may generally rely upon burden information (such as transport-related burden information) as well as flow information within the geographic area as part of a watershed type of analysis to determined how to break up the geographic area into appropriately smaller seed areas when attempting to balance workloads within the geographic area. Doing so allows for consideration of transportation connectivity, geographic features, and historic business information as explained below.

FIG. 1 is a diagram of an exemplary computer system deployed in a sample networked operating environment in accordance with an embodiment of the invention. Referring now to FIG. 1, an exemplary geographic information server computer system 100 is illustrated as being responsible for partitioning an original geographic area into smaller subdivisions or areas as part of balancing business-related workloads. In particular, the geographic information server 100 is illustrated operatively coupled or otherwise in communication with other networked devices, such as computer systems (at least business management server 110) and network storage devices (such as GIS data storage 115) via network 105.

Those skilled in the art will appreciate that network 105 may be a general data communication network involving a variety of communication networks or paths, such as hard wired structures (e.g., LAN, WAN, telecommunication lines, telecommunication support structures and telecommunication processing equipment, etc.), wireless structures (e.g., antennas, receivers, modems, routers, access points, repeaters, etc.) and/or a combination of both depending upon the desired implementation of a network that interconnects server 100 and other components shown in FIG. 1 in an embodiment of the present invention.

The exemplary business management server 110, as shown in FIG. 1, is a type of general computing platform used by a business for business operations, such as managing sales, inventory, and/or other business purposes in the operation of the business. For example, business management server 110 may be involved in dispatch operations for the business' service calls to customers. In another example, business management server 110 may be involved in logistics operations, such as planning or otherwise managing delivery, tracking, and/or pickup activities for customer packages. In yet another example, business management server 110 may be involved in general sales operations, such as territory management, sales tracking, and inventory management for the business. In an embodiment, the business operating business management server 110 may desire to take advantage of optimized information generated and provided by the geographic information server 100 as part of business-related workload balancing operations. Thus, in an embodiment, business management server 110 may operate to send a request to geographic information server 100 for such information during operation of the business, and receive data structures (as explained in more detail herein) generated by geographic information server 100. Those skilled in the art will appreciate that while server 100 and server 110 are shown in FIG. 1 as different computing platforms, other embodiments may implement features of such servers as part of the same computing platform depending on the complexity of the desired implementation.

Exemplary GIS data storage 115 may be implemented as a memory storage unit, such as a hard drive or other accessible, large capacity memory device. Other embodiments may implement GIS data storage 115 as one or more network accessible servers, one or more network storage devices, a collection of memory storage implemented using cloud storage technology, or the like. Further embodiments may implement GIS data storage 115 as an internal or integral part of geographic information server 100 in order to avoid the need to request and receive exemplary GIS data from GIS data storage over the network 105.

Foundationally, the exemplary GIS data storage 115 provides electronic information regarding the makeup and features within one or more geographic areas. Such electronic information may take the form of transportation networks, hydrography, population characteristics, economic activity, physical geographic features, and types of land use. The electronic information is accessible and used by geographic information system program modules, such as exemplary GIS code explained in FIG. 2, when analyzing geographic features and information related to such geographic features. Typically, such a program module (e.g., code, code section, application, or other collection of programming instruction) provides for spatial data entry, management, retrieval, analysis, and visualization functions and relies upon the electronic information maintained in GIS data storage 115.

FIG. 2 is a more detailed diagram illustrating exemplary hardware and software components in the exemplary computer system represented as the exemplary geographic information server 100 in FIG. 1. Further details on various embodiments that take advantage of these hardware elements and this functionality as embodied in the programmed hardware elements are explained below.

Referring now to FIG. 2, the exemplary geographic information server 100 is shown in more detail as a computing platform capable of connecting to and interacting with at least other computers and memory systems, such as business management server 110 and GIS data storage 115, over network 105. Those skilled in the art will appreciate that exemplary geographic information server 100 is a hardware-based component that may be implemented in a wide variety of ways. For example, server 100 may be implemented with a laptop or desktop type of computer, which may use a single processor (such as processing unit 200) or may be implemented as one or more parts of a more complex multi-processor or parallel processor component. Furthermore, those skilled in the art will further appreciate that while server 100 may be implemented as a single computing system (such as a laptop or desktop type of computer), server 100 may be implemented as a more complex distributed server (e.g., separate servers for separate server related tasks), a hierarchical server (e.g., a server implemented with multiple levels where information may be maintained at different levels and tasks performed at different levels depending on implementation), or a server farm that logically allows multiple distinct components to function as one server computing platform device from the perspective of other networked devices (e.g., business management server 110 and GIS data storage 115). In some regional deployments, an exemplary server may include servers dedicated for specific geographic regions as information collected within different regions may include and be subject to different regulatory controls and requirements implemented on respective regional servers.

Likewise, while the embodiment shown in FIG. 2 illustrates a single memory storage 215, exemplary geographic server 100 may deploy and use more than one memory storage media as well as more than one type of memory storage media. In more detail, such memory storage media are types of computer-readable medium and may be in differing non-transitory forms (e.g., conventional hard disk drives, solid state memory such as flash memory, optical drives, RAID systems, cloud storage configured memory, network storage appliances, etc.).

At its core, exemplary geographic information server 100 shown in the embodiment of FIG. 2 comprises a processing or logic unit 200 coupled to memory storage 215, volatile memory 220, onboard database storage 225, a network interface 230, and (optionally) a local user interface 205. As a computing platform, the processing unit 200 of exemplary server 100 is operatively coupled to memory storage 215 and volatile memory 220, which collectively store and provide a variety of executable program code and other data for operation and use by the processing unit 200. In more detail, exemplary memory storage 215 may be a tangible, non-transient computer readable medium on which instructions embodied in executable program code as well as types of data may be maintained as exemplary executable code/modules (e.g., GIS code 235 and selective partitioning code 240), data accessed from other networked devices and stored locally (e.g., GIS data 245), data locally maintained and accessed (e.g., business-related metric information), and information and other data structures generated during operation of the geographic information server 100 (e.g., seed data structures) may be kept in a non-volatile and non-transitory manner.

As noted above, an embodiment of GIS code 235 may provide code for analyzing GIS electronic information (e.g., GIS data 245) as part of providing functions of spatial data entry, management, retrieval, analysis, and visualization functions for the GIS data 245. In a particular embodiment, the GIS code 235 may be implemented with ESRI ArcGIS Server software that is capable of manipulating GIS data, such as GIS data 245, that represents an original geographic area.

In an embodiment, the exemplary GIS code 235 is utilized as a GIS type of data analysis tool by exemplary selective partitioning code 240, which is operative to intelligently partition the original geographic area into smaller and more effective areas referred to as logical seed areas or simply seed areas. Generally, exemplary selective partitioning code 240 may accomplish this by directing a watershed type of analysis, which may involve calls to GIS code 235. In more detail, an embodiment has exemplary selective partitioning code 240 providing instructions to GIS code 235 on how/where to break up the original geographic area, while GIS code 235 is operative to manipulate the GIS data related to the original geographic area to accomplish this pursuant to the instructions and information provided by selective partitioning code 240. Thus, selective partitioning code 240, working with GIS code 235, effectively generate multiple data structures 255 that, respectively, represent each of the seed areas.

Other data (not shown in FIG. 2) may be generated or used as the selective partitioning code 240 operates during the watershed analysis, such as transport-related burden information within the original geographic area and transport-related flow information within the original geographic area. With this, the selective partitioning code 240 is then operative to transform one or more of the seed areas into subdivided areas as part of balancing a business-related workload based on business-related metric information 250 (e.g., historic business information, such as sales or logistics related historic information for the respective areas).

While the seed data structures 255 are shown in FIG. 2 as being maintained in volatile memory 220 as they are generated, and maintained in memory storage 215 as a non-transitory form of the data structures 255, such data structures may be stored and maintained on a locally accessible database 225 coupled to processing unit 200. In other embodiments, the seed data structures 255 may be stored either on the memory storage 215 or the database 225. In another embodiment, the seed data structure 255 may be stored in both non-transitory memory mediums.

In a more detailed embodiment, the seed data structures 255 may be generated and stored as database records or files having particular related elements. For example, in one embodiment, one of the seed data structures 255 representing a part of the original geographic area may be stored in a data structure 260a having a first element and a second element. The first element is a seed area ID that identifies the particular logical seed area within the original geographic area, while the second element is a seed point ID that identifies a seed point. As explained in a more detail embodiment below, a seed point may identify an entry or exit point for a respective one of the logical geographic seed areas.

In one embodiment, database 225 is an Oracle database used for maintaining data structures formatted as related items. While not expressly shown in FIG. 2, those skilled in the art will also appreciate that other similarly formatted data structures (e.g., 260b, 260c, 260d . . . ) that respectively represent the other logical seed areas within the geographic area and collectively are maintained as a related set of data structures 255 within database 225.

Those skilled in the art will also appreciate that the above identification of particular executable program code and data are not exhaustive and that other embodiments may include further executable program code or modules as well as other data relevant to operations of processing unit 200 in geographic information server 100. For example, those skilled in the art will appreciate that geographic information server 100 may be implemented as a server operating with a Linux operating system. Such an operating system (not shown in FIG. 2) is loaded from memory storage 215 into volatile memory 220 as the server 100 boots up and configures itself to operate and be able to execute the instructions that make up executable program code, such as GIS code 235 and selective partitioning code 240. Thus, when server 100 is executing the underlying operating system as well as the other executable program code (e.g., GIS code 235 and selective partitioning code 240), server 100 is specifically configured and adapted to function in a way (as described below) that is advantageous and different when compared to a simple or generic computer.

Referring back FIG. 2, the network interface 230 facilitates and enables operative connections and communications through network 105. For example, network interface 230 may receive a request from another computing device (e.g., business management server 110) to balance a business-related workload related to a particular geographic area. Such a request may be received through network interface 230 when, for example, logistic routes are being planned or optimized. Once the geographic information server 100 has partitioned the geographic area into optimally manageable smaller logical seed areas that balance the workloads according to one or more of the business-related metrics (and transformed any of the seed areas into even smaller areas as desired when balancing), the generated seed data structures may be sent back to the requesting computing device over the network interface 230.

FIG. 2 also illustrates a local user interface 205 as an optional element coupled to the processing unit 200 within server 100. In one example, such a user interface may include a keyboard, display, and other human input device (e.g., mouse, track pad, touch screen, button, switch, etc.). However, in another example, server 100 may be remotely managed so as to not require a local user interface.

In the exemplary context of such a processor-based computing system and networked environment illustrated in embodiments of FIGS. 1-2, FIGS. 3-8 provide illustrative diagrams of an exemplary geographic area as it is partitioned into seed areas having seed points. Such illustrative diagrams show aspects of how the geographic area may be initially subdivided into units (e.g., a grid of cells or other polygons), and then transport-related burden information and transport-related flow information are relied upon to break up the original geographic area into smaller areas as workload balancing may occur in one or more embodiments.

In more detail, FIG. 3 is a diagram of an exemplary original geographic area in accordance with an embodiment of the invention. Referring now to FIG. 3, the exemplary original geographic area 300 is shown collectively having an exemplary street network or other transportation network 310 as well as different geographic features 305. For example, transportation network 310 may include different types of roadways, such as local roads or streets, bridges, tunnels, local highways, or large interstate highways with controlled or more limited access. In an embodiment, the different geographic features 305, for example, may include a variety of different features, such as rivers, lakes, mountains, valleys, parks, and the like. While the detail provided in FIG. 3 for such exemplary features 305 and transportation networks 310 may be simple, those skilled in the art will understand and appreciate that such features and networks may be extensive, diverse, and detailed in other embodiments of exemplary area 300.

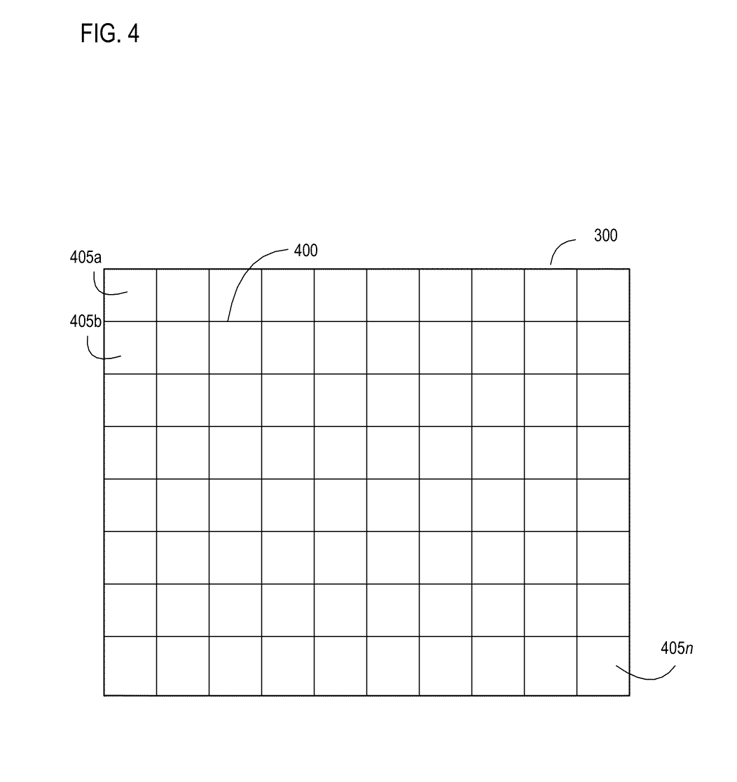

To break up or optimally partition exemplary geographic area 300 into smaller areas that achieve a business-related workload balance, area 300 may be initially divided or partitioned into smaller units. FIG. 4 is an diagram of the exemplary geographic area partitioned into an exemplary grid of units in accordance with an embodiment of the invention. Referring now to FIG. 4, exemplary geographic area 300 (without the street network 310 and geographic features 305) is shown partitioned into multiple units (collectively 400). In more detail, each of the units may be implemented as a cell from a plurality of cells representing the original geographic area, a grid element from a plurality of grid elements representing the original geographic area, a designated shape from a plurality of designated shapes representing the original geographic area, or a polygon from a plurality of polygons representing the original geographic area.

As shown in the particular embodiment of FIG. 4, the units 400 may be implemented as a grid of cells (i.e., 405a, 405b . . . 405n) with each cell representing a 50 square meter part of the original geographic area 300. Those skilled in the art will appreciate that the size and shape of the units may be altered depending on the geographic area 300 and compute resources of server 100 so that a timely and useful solution may be prepared that transforms the original geographic area 300 into intelligently manageable seed areas.

Once geographic area 300 has been partitioned into such units, a further watershed type of analysis may be performed that helps determine how to effectively break up the geographic area 300 into the intelligently manageable seed areas based in part on transport-related burden information or data assembled by the computer system. In general, transport-related burden data corresponds to information related to impeded transportation. More specifically, transport-related burden data for a particular unit (such as cell 405a of grid 400) reflects an ease or impediment to transportation within the particular unit. In one embodiment, a higher value for transport-related burden data may correspond to more impeded transport within a unit, while a lower value for transport-related burden data may correspond to less impeded transport within the unit. However, those skilled in the art will appreciate the in an alternative embodiment, a higher value for transport-related burden data may correspond to less impeded transport within a unit, while a lower value for transport-related burden data may correspond to more impeded transport within the unit.

In an embodiment, there may be different types or categories of transport-related burden data that may impact transport within units, and those different types may be combined or assembled in an advantageous manner. In general, transport-related burden data may be determined for each unit so as to provide a transport-related burden surface related to the original geographic area. And more than one type of transport-related burden data may be relied upon to determine a composite value for such transport-related burden data related to each particular unit. Thus, different types of transport-related burden data may be combined to effectively quantify an effort to traverse each of the units. The resulting combined transport-related burden data is a composite transport-related burden value for each of the units within the original geographic area.

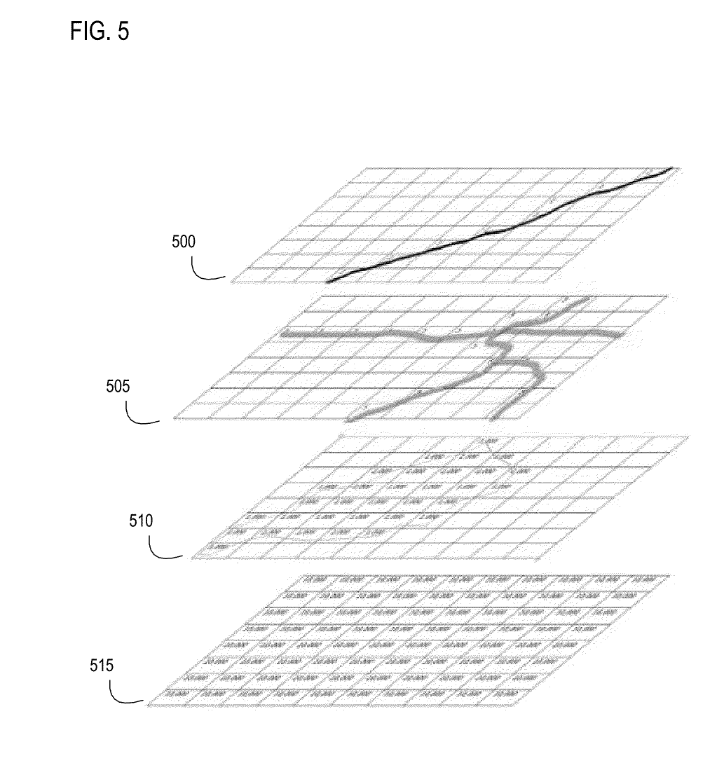

FIG. 5 is a diagram of exemplary sets of different types of exemplary transport-related burden data that collectively may be combined or assembled to make up a composite transport-related burden value for each of the units in area 300 in accordance with an embodiment of the invention. Referring now to FIG. 5, different types of exemplary transport-related burden data 500-515 are illustratively shown as values for one or more particular units in the grid 400 related to the geographic area 300. A first type 515 of transport-related burden data may correspond to an initial or default value for each unit, where the value represents substantially impeded transport within the unit area. In the illustrated example shown in FIG. 5, the value of each unit is set to an example value of 10,000 to reflect a substantially impeded transport within each cell.

Other types of transport-related burden data may be combined with the initial value shown for the first type 515 to change the value for particular units in grid 400 for geographic area 300. For example, at least one more additional types of transport-related burden data respectively may represent one or more types of transportation routes or one or more types of geographic features that impact transport. In more detail, such additional types of transport-related burden data may correspond to different subsets of the units and those units may relate to a service area, a facility location, a military base, a land use type (e.g., commercial, residential, industrial, park land, etc.), an interstate highway, a local highway, a local road, a bridge, a tunnel, a railroad line, a mountain, a valley, or a body of water.

Referring back to FIG. 5, a second exemplary type 510 of transport-related burden data may correspond to a value for a subset of the units, where the value represents the ease of transport for traversing water bodies. In the illustrated example shown in FIG. 5, the value of particular units for type 510 is set to an example value of 1,000 to reflect an even less impeded transport in those particular units.

A third exemplary type 505 of transport-related burden data may correspond to a value for another subset of the units, where the value represents the ease of transport for traversing local roads. In the illustrated example shown in FIG. 5, the value of particular units for type 505 is set to an example value of 5 to reflect an even further reduced impediment to transport in those particular units.

A fourth exemplary type 505 of transport-related burden data may correspond to a value for still another subset of the units, where the value represents the ease of transport for traversing highways. In the illustrated example shown in FIG. 5, the value of particular units for type 500 is set to an example value of 2 to reflect a least type of impediment to transport in those particular units.

In general, when combining the values from each type of transport-related burden data for a particular unit in the grid 400, an embodiment may keep the value reflecting the least impediment to transport. For example, a particular unit may have a value of 10,0000 from the first type of transport-related burden data and a value of 5 from the third type of transport-related burden data given that particular unit has local roads within it. As a result, the composite value for the particular unit would be 5 in this embodiment to reflect the ease at which there is to traverse the unit.

In another embodiment, one or more types of transport-related burden data may be given a priority or override status when compared to certain or all other types of the transport-related burden data. This may allow for a type of customization to further reflect the ease of transport as well as other factors outside of what type of street or geographic feature is present in certain units. For example, while some roads may be similar to other roads, they may differ in that they are toll roads. And in one embodiment, it may be desired to avoid certain toll roads given their incumbent increased impediment to transport. In another example, some roads may only be selectively available (e.g., gated facilities or areas with very controlled access), which may also decrease the ease of transport for a unit having such roads.

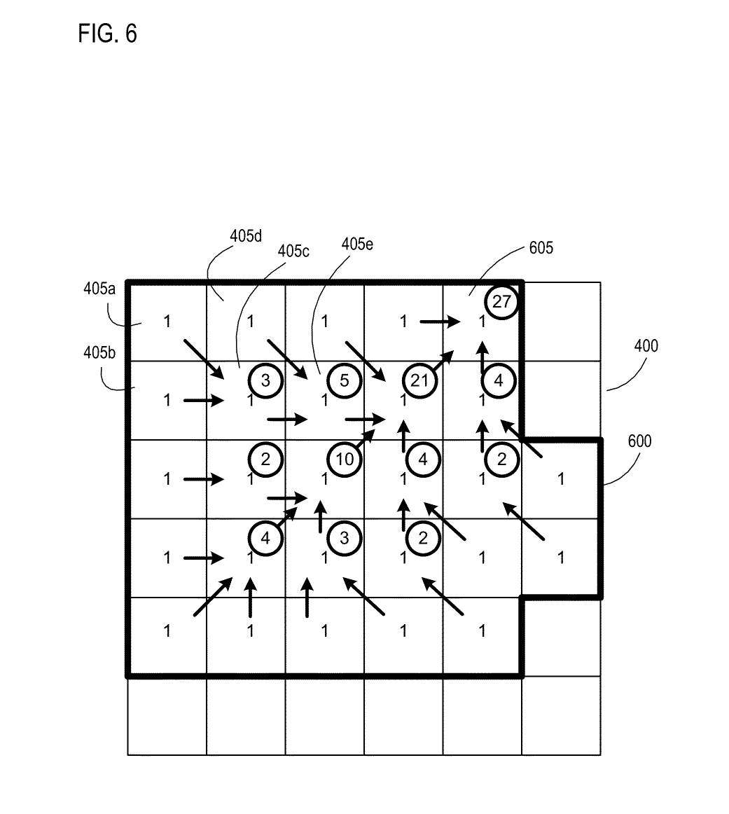

With a composite value for transport-related burden data in each of the units for geographic area 300, such information may be used by the computer system in an embodiment to determine transport-flow related information used in the partitioning and transformation performed as the seed areas are generated. FIG. 6 is an diagram illustrating exemplary transport-related flow information for the exemplary geographic area in accordance with an embodiment of the invention. Referring now to FIG. 6, an exemplary grid 600 (e.g., a portion of grid 400 simplified for ease of description) may generally illustrate how transport-related flow information may be determined in an embodiment. In one embodiment, the transport-related flow information may include flow direction information as well as flow accumulation information. These two types of flow information may be based upon the composite values of transport-related burden data in each unit of the area 300, and are used to characterize arteries of transportation going from the harder to access parts of the area to essentially collection points which are increasingly easier to reach via transportation.

In more detail, an embodiment has the selective partitioning code operatively functioning to determine the transport-related flow information for the original geographic area as (1) a flow direction associated with each of the units and (2) a flow accumulation associated with each of the units. For example, the flow direction may be based collectively on the composite transport-related burden information for the unit and surrounding ones of the units relative to the unit. As such, the flow direction for a unit is the direction (from that unit to another of the surrounding units) where the direction points to a unit with an easier transport burden (e.g., having a composite transport-related burden value indicating travel within the pointed to unit is easier than within the unit under consideration). Referring to the example shown in FIG. 6, the flow direction for unit or cell 405a may be based collectively on the composite transport-related burden information for that unit 405a and surrounding ones of the units relative to the unit. As such, the composite transport-related burden information for unit 405c (one of the units surrounding unit 405a) is determined to be lower than the composite transport-related burden information for unit 405a. As a result, an arrow shown in FIG. 6 from unit 405a to unit 405c represents a flow direction for unit 405a. A similar analysis may be done for unit 405b, which determines the flow direction for unit 405b is represented as an arrow from unit 405b to unit 405c, which has the lowest composite transport-related burden information of those units surrounding unit 405b. Thus, as shown in FIG. 6, a flow direction for a particular unit (represented by the arrows illustrated in FIG. 6) shows where transportation would more easily come from or exit to for a particular unit relative to any of the surrounding units based on compared transport-related burden.

Based on the flow direction for units in grid 400, a flow accumulation may be determined. In an embodiment, the flow accumulation for each unit may be based on how many others of the units collectively direct transport through the particular unit. As such, the flow directions show ease of transport from one unit to another, and as

As shown in the example illustrated in FIG. 6, each of the units is logically represented as a “1” in their respective unit. Using the flow direction arrows, each of which showing where easier or less impeded traffic or transportation modes exist relative to a particular unit, a flow accumulation determination may be accomplished that adds up how many others of the units would have transport directed through that unit or could be reached when traveling along the flow direction into that unit. In the example shown in FIG. 6, unit 405c has flow direction arrows indicating that accumulated transport from both units 405a and 405b would flow into unit 405c. Thus, the accumulated flow (i.e., flow accumulation) for unit 405c would total 3 (shown in the circled symbol within unit 405c)—i.e., 1 for itself, 1 from unit 405a, and 1 from unit 405b.

This is repeated as flow is accumulated from outer edges of grid 400. For example, unit 405c has a flow direction reflected by an arrow from unit 405c to unit 405e and unit 405d has a flow direction reflected by an arrow from unit 405d to unit 405e. Thus, the accumulated flow for unit 405e would total 5 (shown in the circled symbol within unit 405e)—i.e., 1 for itself, 1 from unit 405d, and 3 from unit 405c.

Effectively, this determination identifies units in the area 300 that operate as hubs for easy transport to a given number of other units. Thus, in the example shown in FIG. 6, the unit 605 having a flow accumulation value of 27 operates as an area through which to provide easier transport to the 26 other units that “flow through” unit 605. And the related 26 other units that would “flow through” unit 605 are designated as the portion 600 of grid 400.

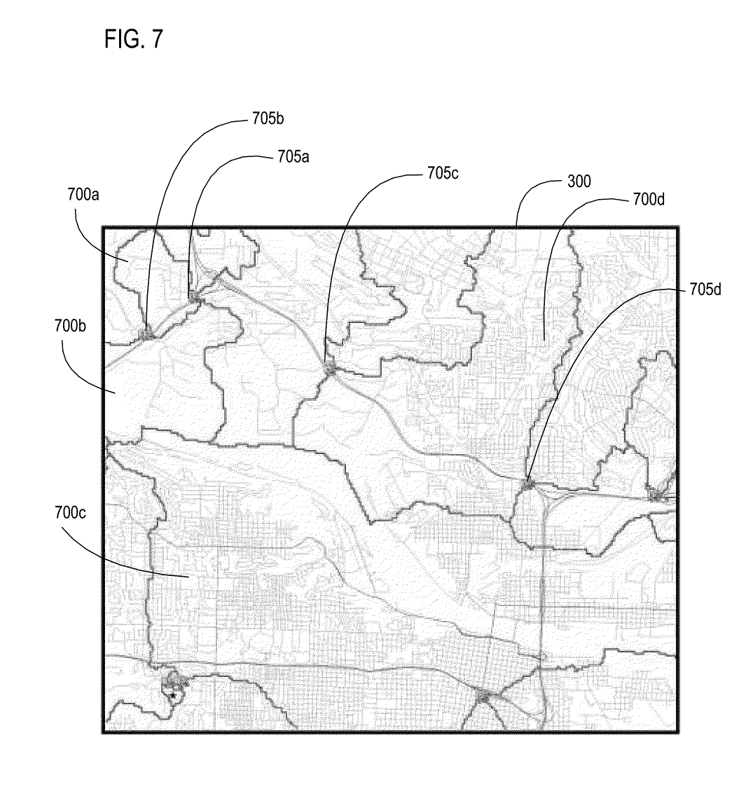

With a particular flow accumulation value, the exemplary geographic area 300 may be broken up or partitioned into multiple different areas logically labeled as “seed” areas where units within the particular seed area may be access by entering or exiting through the unit having the particular flow accumulation value (also generally called a “seed point”). FIG. 7 is an diagram of the exemplary geographic area separated into an exemplary group of logical geographic seed areas in accordance with an embodiment of the invention. Referring now to FIG. 7, exemplary subdivisions of original geographic area 300 are shown as exemplary logical seed areas 700a, 700b, 700c, 700d . . . while seed points for the seed areas are shown as 705a, 705b, 705c, 705d, etc.

In this embodiment, the seed points identified within the original geographic area 300 are those of the units having a designated value for the flow accumulation value of interest for a “break point.” Thus, if the selective partitioning code uses a smaller designated value for the flow accumulation value of interest, the logical seed areas identified are smaller. And if the selective partitioning code uses a larger designated value for the flow accumulation value of interest, the logical seed areas identified are larger. The appropriate size for such a designated value will, thus, depend upon the metrics of interest and associated workload with such areas. The resulting seed areas and seed points are then represented by data structures (e.g., seed data structures 255) generated by the selective partitioning code having a particularly advantageous format where each data structure has an element identifying the seed area and another element identifying the seed point for the area.

For the collective logical seed areas and related seed points identified by the selective partitioning code, business-related metric information (e.g., business-related metric information 250) may be accessed as part of attempting to balance a business-related workload. In general, business-related metric information is information related to a business workload. In more detail, business-related metric information may be maintained as one or more sets of data geographically related to portions of area 300. For example, at least one set of business-related metric information may generally include historic, current, and/or forecasted or future business information. Such business information may, in a more detailed embodiment, include at least one of sales information associated with each seed area, service information associated with each seed area, and logistics information associated with each seed area. And such logistics information may further include, for example, at least one of delivery information, service type (e.g., a prioritized logistics service or a standard logistics service), type of packages to be delivered or picked up (e.g., envelopes, boxes, crates, etc.), customer specific logistic information (e.g., customer restricted possible delivery or pickup times, customer restricted facility access information), driving time information, stop time information, driving distance information, a number packages delivered, and a number of packages picked up. Additionally, an embodiment may include historic business information as having a population metric, which may relate to the location of existing or potential customers in the seed area, a density of potential or existing customers in the seed area, or other general population density information related to the seed area.

Such business-related metric information may be used by the selective partitioning code to determine whether a business-related workload is substantially balanced with the identified seed areas. And if not, then the selective partitioning code may further subdivide a seed area as part of attempting to balance the workload. For example, in one embodiment, the selective partitioning code generally accesses at least one set of the business-related metric information for each of the logical geographic seed areas from, for example, memory storage 215. The selective partitioning code then determines if the business-related workload for each of the logical geographic seed areas is substantially balanced based upon the at least one business-related metric.

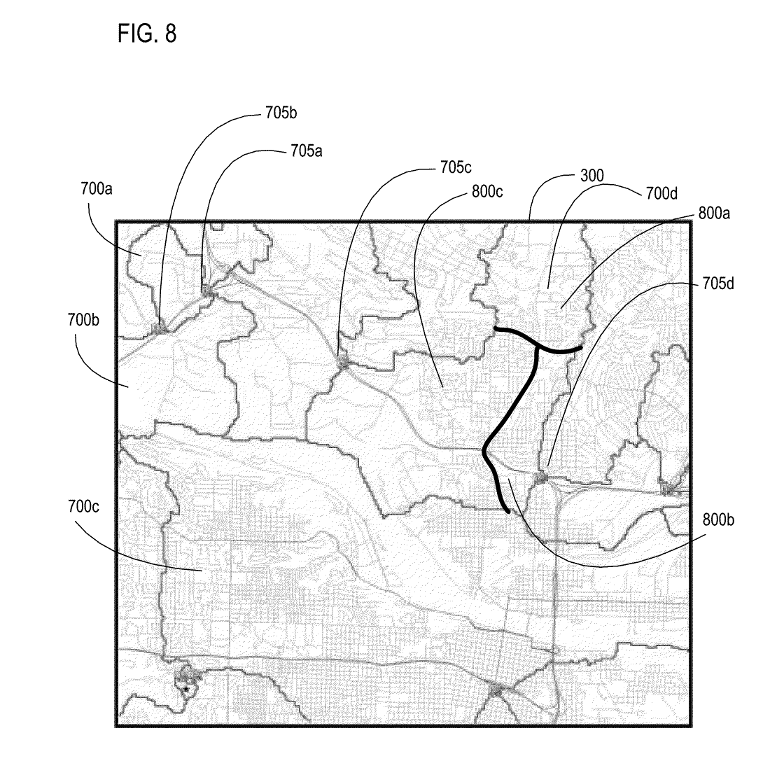

Should an imbalance be determined, then the selective partitioning code operates to transform at least one of the data structures representing one of the logical geographic seed areas into at least two alternative data structures respectively representing a subdivision of that seed area. FIG. 8 is an diagram illustrating one of the exemplary logical geographic seed areas transformed into a subdivision of the seed area in accordance with an embodiment of the invention. Referring now to FIG. 8, exemplary seed area 700d may have business-related metric information that, when compared with the information for other seed areas, indicates seed area 700d has a business-related workload (e.g., sales quota, delivery schedule, service calls) that reflects an imbalance such that seed area 700d is subdivide into even smaller areas 800a, 800b, and 800c to bring the business-related workload back in balance for the area 300.

In an embodiment, the data structures 255 representing the logical geographic seed areas, as well as any alternative data structures representing a subdivision of one or more such seed areas, may be provided by server 100 to other computer systems, such as business management system 110. This may be accomplished by having the processor unit 200 direct the network interface 230 to transmit a communication or other message to the other computer system where the communication includes the data structure 255. Alternatively, the data structures 255 may remain accessible on database 225 (e.g., accessible by the processor 200 of server 100 or by other computers, such as business management system 110).

Such a business-related workload may, for example, include at least one of a service call workload factor, a sales workload factor, or a logistics workload factor. An exemplary service call workload factor may involve a desired level of service calls for a given area so that different service technicians going onsite to customers within different parts of area 300 have a balanced workload. Likewise, an exemplary sales workload factor may involve a desired level of sales quota to be sold within a given area by sales personnel. And similarly, an exemplary logistics workload factor may involve a desired level of pickup and delivery activities for particular delivery personnel.

In general, exemplary methods for partitioning an original geographic area into a plurality of logical geographic seed areas as part of balancing a business-related workload may be implemented with a computer system (such as the geographic information server 100) running executable program modules (such as at least the selective partitioning code 240) and using data and information maintained on the computer system. Further details of exemplary embodiments of such methods are described in more detail below in FIGS. 9 and 10.

FIG. 9 is a flowchart diagram illustrating exemplary steps of a method for partitioning the original geographic area into a plurality of logical geographic seed areas as part of balancing a business-related workload in accordance with an embodiment of the invention. Referring now to FIG. 9, the exemplary method 900 begins at step 905 where a computer system (such as the geographic information server 100) generates a plurality of data structures in a memory (such as seed data structures 255 maintained in memory storage 215 or database 225) respectively representing the plurality of logical geographic seed areas based upon a watershed analysis of transport-related burden information within the original geographic area and transport-related flow information within the original geographic area. The data structures generated each comprise a first data element identifying one of the logical geographic seed areas and a second data element identifying one of a plurality of seed points corresponding to a transport interface for the respective one of the logical geographic seed areas.

At step 910, method 900 continues with the computer system accessing at least one set of business-related metric information for each of the logical geographic seed areas. The set or sets of business-related metric information are maintained on a memory storage operatively coupled to the computer system, such as business-related metric information 250 stored in memory storage 215, which is operatively coupled to processing unit 200 of server 100.

In a further embodiment of method 900, the business-related metric information may be implemented as business information, such as a population metric (e.g., customers in the area, customer density, non-customers in the area, general population and population density). Such business information may be historic based on past business operations, current, or future based on forecasted or projected business information. Furthermore, such business information may include sales information associated with each of the logical geographic seed areas, service information associated with each of the logical geographic seed areas, and logistics information associated with each of the logical geographic seed areas. In yet a further embodiment, the logistics information may include delivery information, service type, type of packages, customer specific logistic information, driving time information, stop time information, driving distance information, a number packages delivered, and a number of packages picked up.

At step 915, method 900 continues with the computer system determining if the business-related workload for each of the logical geographic seed areas is substantially balanced based upon the at least one business-related metric.

And at step 920, method 900 concludes with the computer system transforming at least one of the data structures representing one of the logical geographic seed areas into at least two alternative data structures. Each of the alternative data structures, respectively, represents a subdivision of one of the logical geographic seed areas when at least one business-related metric reflects an imbalance in the business-related workload for that particular one of the logical geographic seed areas.

In a further embodiment where one seed area is split up, method 900 may implement the transforming step by comparing the business-related workload for each of the logical geographic seed areas to identify the one of the logical geographic seed areas having a higher business-related workload than the remaining logical geographic seed areas. The identified one of the logical geographic seed areas may then be redefined into a plurality of smaller seed areas, where each of the smaller seed areas and the remaining logical geographic seed areas have a substantially balanced business-related workload.

In still another embodiment where more than one seed area may be need adjustment to balance the workload, method 900 may implement the transforming step by comparing the business-related workload for each of the logical geographic seed areas to identify a plurality of the logical geographic seed areas having a higher business-related workload than a threshold. The identified plurality of logical geographic seed areas are then redefined into a plurality of smaller seed areas, where each of the smaller seed areas and the remaining logical geographic seed areas have a substantially balanced business-related workload.

FIG. 10 is a more detailed flowchart diagram illustrating exemplary steps for partitioning the original geographic area as part of step 905 recited in method 900 in accordance with a more detailed embodiment of the invention. The steps of more detailed method 1000 for partitioning the original geographic area begin at step 1005, which has the computer system partitioning the original geographic area into a plurality of units (e.g., cells, polygons). In a further embodiment of method 1000, each of the units may further be implemented as a variety of shaped items, such as a cell from a plurality of cells representing the original geographic area, a grid element from a plurality of grid elements representing the original geographic area, a designated shape from a plurality of designated shapes representing the original geographic area, or a polygon from a plurality of polygons representing the original geographic area.

At step 1010, the method 1000 continues by combining different types of transport-related burden data to quantify an effort to traverse each of the units. The resulting combined transport-related burden data is a composite transport-related burden value for each of the units within the original geographic area. As a result, the composite value for each unit reflects an ease with which to traverse the unit within the geographic area.

In a further embodiment of method 1000, the different types of transport-related burden data may comprise a first type corresponding to a value for substantially impeded transport within the unit and at least one more additional type of transport-related burden data respectively representing one or more types of transportation routes within the unit (e.g., local roads, highways, bridges, ferry crossings). The additional type of transport-related burden data may also reflects one or more types of geographic features that impact transport. And in a more detailed embodiment, such additional types of transport-related burden data may include at least one more additional type of transport-related burden data respectively comprises data for a portion of the units that represent the original geographic area, the portion being associated with at least one of a service area (such as a business service area or business territory), a facility location, a military base, a land use type (such as residential, commercial, industrial, park land, designated historic property, or the like), an interstate highway, a local highway, a local road, a bridge, a tunnel, a ferry, a railroad line, a mountain, a valley, or a body of water.

In a further embodiment, at least one of the additional types of transport-related burden data may be designated as a priority type of the transport-related burden data. As such, the priority type of transport-related burden data overrides one or more of the other types of transport-related burden data as the different types are being combined.

At step 1015, the method 1000 continues by determining the transport-related flow information for the original geographic area. The transport-related flow information includes a flow direction and a flow accumulation respectively associated with each of the units. The flow direction is based collectively on the composite transport-related burden information for the unit and surrounding ones of the units relative to the unit. In a more detailed embodiment, the flow direction is generally the direction from the particular unit to a surrounding one of the units that has the easiest travel or transport-related burden reflected by its composite transport-related burden information. The flow accumulation for a particular unit is based on how many others of the units collectively direct transport through the particular unit based on flow directions.

At step 1020, the method 1000 continues by identifying a plurality of seed points within the original geographic area as those of the units having a designated value for the flow accumulation. And based upon such seed points, at step 1025, the method 1000 continues by identifying each of the logical geographic seed areas as collectively including those of the units that respectively flow to each of the seed points.

It should be emphasized that the sequence of operations to partition the original geographic area into smaller logical seed areas described herein (such as those set forth above with respect to FIGS. 9 and 10) is merely an example, and that a variety of sequences of operations to perform such steps may be followed while still being true and in accordance with the principles of the present invention.

At least some portions of exemplary embodiments outlined above may be used in association with portions of other exemplary embodiments. Moreover, at least some of the exemplary embodiments disclosed herein may be used independently from one another and/or in combination with one another and may have applications to devices and methods not disclosed herein.

Those skilled in the art will appreciate that embodiments may provide one or more advantages, and not all embodiments necessarily provide all or more than one particular advantage as set forth here.

It will be apparent to those skilled in the art that various modifications and variations can be made to the structures and methodologies described herein. Thus, it should be understood that the invention is not limited to the subject matter discussed in the description. Rather, the present invention is intended to cover modifications and variations.

1. An improved method for partitioning an original geographic area into a plurality of logical geographic seed areas as part of balancing a business-related workload, comprising:
receiving a request, by a computer system, from a business management server computer tasked with balancing the business-related workload related to the original geographic area;
generating, by the computer system, a plurality of data structures in a memory respectively representing the plurality of logical geographic seed areas based upon a watershed analysis of transport-related burden information within the original geographic area and transport-related flow information within the original geographic area, wherein each of the data structures generated comprises a first data element identifying one of the logical geographic seed areas and a second data element identifying one of a plurality of seed points corresponding to a transport interface for the respective one of the logical geographic seed areas;
accessing, by the computer system, at least one set of business-related metric information for each of the logical geographic seed areas, the at least one set of business-related metric information being maintained on a memory storage operatively coupled to the computer system;
determining, by the computer system, if the business-related workload for each of the logical geographic seed areas is substantially balanced based upon the at least one business-related metric;
transforming, by the computer system, at least one of the data structures representing one of the logical geographic seed areas into at least two alternative data structures respectively representing a subdivision of the one of the logical geographic seed areas when the at least one business-related metric reflects an imbalance in the business-related workload for the one of the logical geographic seed areas; and
transmitting, by the computer system to the business management server, at least the two alternative data structures representing the subdivision of the one of the logical geographic seed areas.

2. The method of claim 1, wherein the generating step further comprises:
partitioning the original geographic area into a plurality of units;
combining different types of transport-related burden data to quantify an effort to traverse each of the units, wherein the resulting combined transport-related burden data being a composite transport-related burden value for each of the units within the original geographic area;
determining the transport-related flow information for the original geographic area as (1) a flow direction associated with each of the units, the flow direction being based collectively on the composite transport-related burden information for the unit and surrounding ones of the units relative to the unit, and (2) a flow accumulation associated with each of the units, the flow accumulation for a particular unit being based on how many others of the units collectively direct transport through the particular unit;
identifying a plurality of seed points within the original geographic area as those of the units having a designated value for the flow accumulation; and
identifying each of the logical geographic seed areas as collectively including those of the units that respectively flow to each of the seed points.

3. The method of claim 2, wherein each of the units further comprises one from a group comprising a cell from a plurality of cells representing the original geographic area, a grid element from a plurality of grid elements representing the original geographic area, a designated shape from a plurality of designated shapes representing the original geographic area, or a polygon from a plurality of polygons representing the original geographic area.

4. The method of claim 2, wherein the different types of transport-related burden data comprises a first type corresponding to a value for substantially impeded transport and at least one more additional type of transport-related burden data respectively representing one or more types of transportation routes.

5. The method of claim 4, wherein the at least one more additional type of transport-related burden data respectively reflects one or more types of geographic features that impact transport.

6. The method of claim 5, wherein the at least one more additional type of transport-related burden data respectively comprises data for a portion of the units that represent the original geographic area, the portion being associated with at least one of a service area, a facility location, a military base, a land use type, an interstate highway, a local highway, a local road, a bridge, a tunnel, a ferry, a railroad line, a mountain, a valley, or a body of water.

7. The method of claim 2, wherein the at least one more additional type of transport-related burden data further comprises a priority type of the transport-related burden data that overrides one or more of the other types of transport-related burden data.

8. The method of claim 1, wherein the at least one set of business-related metric information further comprises business information.

9. The method of claim 8, wherein the business information further comprises at least one of sales information associated with each of the logical geographic seed areas, service information associated with each of the logical geographic seed areas, and logistics information associated with each of the logical geographic seed areas.

10. The method of claim 9, wherein the logistics information further comprises at least one of delivery information, type of logistics server, type of logistics packaging, customer specific logistic information, driving time information, stop time information, driving distance information, a number packages delivered, and a number of packages picked up.

11. The method of claim 8, wherein the business information further comprises at least one of a population metric.

12. The method of claim 1, wherein the transforming step further comprises:
comparing the business-related workload for each of the logical geographic seed areas to identify the one of the logical geographic seed areas having a higher business-related workload than the remaining logical geographic seed areas; and
redefining the identified one of the logical geographic seed areas into a plurality of smaller seed areas, wherein each of the smaller seed areas and the remaining logical geographic seed areas have a substantially balanced business-related workload.

13. The method of claim 1, wherein the transforming step further comprises:
comparing the business-related workload for each of the logical geographic seed areas to identify a plurality of the logical geographic seed areas having a higher business-related workload than a threshold; and
redefining the identified plurality of logical geographic seed areas into a plurality of smaller seed areas, wherein each of the smaller seed areas and the remaining logical geographic seed areas have a substantially balanced business-related workload.

14. The method of claim 1, wherein each of the seed points identify an entry or exit point for a respective one of the logical geographic seed areas.

15. The method of claim 1, wherein the business-related workload comprises at least one of a service call workload factor, a sales workload factor, or a logistics workload factor.

16. A non-transitory computer-readable medium containing instructions, which when executed on a processor, performs an improved method for partitioning an original geographic area into a plurality of logical geographic seed areas as part of balancing a business-related workload, the method comprising:
receiving a request, by a computer system, from a business management server computer tasked with balancing the business-related workload related to the original geographic area;
generating, by the computer system, a plurality of data structures in a memory respectively representing the plurality of logical geographic seed areas based upon a watershed analysis of transport-related burden information within the original geographic area and transport-related flow information within the original geographic area, wherein each of the data structures generated comprises a first data element identifying one of the logical geographic seed areas and a second data element identifying one of a plurality of seed points corresponding to a transport interface for the respective one of the logical geographic seed areas;
accessing, by the computer system, at least one set of business-related metric information for each of the logical geographic seed areas, the at least one set of business-related metric information being maintained on a memory storage operatively coupled to the computer system;
determining, by the computer system, if the business-related workload for each of the logical geographic seed areas is substantially balanced based upon the at least one business-related metric;
transforming, by the computer system, at least one of the data structures representing one of the logical geographic seed areas into at least two alternative data structures respectively representing a subdivision of the one of the logical geographic seed areas when the at least one business-related metric reflects an imbalance in the business-related workload for the one of the logical geographic seed areas; and
transmitting, by the computer system to the business management server, at least the two alternative data structures representing the subdivision of the one of the logical geographic seed areas.

17. The non-transitory computer-readable medium of claim 16, wherein the generating step further comprises:
partitioning the original geographic area into a plurality of units;
combining different types of transport-related burden data to quantify an effort to traverse each of the units, wherein the resulting combined transport-related burden data being a composite transport-related burden value for each of the units within the original geographic area;
determining the transport-related flow information for the original geographic area as (1) a flow direction associated with each of the units, the flow direction being based collectively on the composite transport-related burden information for the unit and surrounding ones of the units relative to the unit, and (2) a flow accumulation associated with each of the units, the flow accumulation for a particular unit being based on how many others of the units collectively direct transport through the particular unit;
identifying a plurality of seed points within the original geographic area as those of the units having a designated value for the flow accumulation; and
identifying each of the logical geographic seed areas as collectively including those of the units that respectively flow to each of the seed points.

18. The non-transitory computer-readable medium of claim 17, wherein
each of the units further comprises one from a group comprising a cell from a plurality of cells representing the original geographic area, a grid element from a plurality of grid elements representing the original geographic area, a designated shape from a plurality of designated shapes representing the original geographic area, or a polygon from a plurality of polygons representing the original geographic area.

19. The non-transitory computer-readable medium of claim 17, wherein the different types of transport-related burden data comprises a first type corresponding to a value for substantially impeded transport and at least one more additional type of transport-related burden data respectively representing one or more types of transportation routes.

20. The non-transitory computer-readable medium of claim 19, wherein the at least one more additional type of transport-related burden data respectively reflects one or more types of geographic features that impact transport.

21. The non-transitory computer-readable medium of claim 20, wherein the at least one more additional type of transport-related burden data respectively comprises data for a portion of the units that represent the original geographic area, the portion being associated with at least one of a service area, a facility location, a military base, a land use type, an interstate highway, a local highway, a local road, a bridge, a tunnel, a ferry, a railroad line, a mountain, a valley, or a body of water.

22. The non-transitory computer-readable medium of claim 17, wherein the at least one more additional type of transport-related burden data further comprises a priority type of the transport-related burden data that overrides one or more of the other types of transport-related burden data.

23. The non-transitory computer-readable medium of claim 16, wherein the at least one set of business-related metric information further comprises business information.

24. The non-transitory computer-readable medium of claim 23, wherein the business information further comprises at least one of sales information associated with each of the logical geographic seed areas, service information associated with each of the logical geographic seed areas, and logistics information associated with each of the logical geographic seed areas.

25. The non-transitory computer-readable medium of claim 24, wherein the logistics information further comprises at least one of delivery information, type of logistics server, type of logistics packaging, customer specific logistic information, driving time information, stop time information, driving distance information, a number packages delivered, and a number of packages picked up.

26. The non-transitory computer-readable medium of claim 23, wherein the business information further comprises at least one of a population metric.

27. The non-transitory computer-readable medium of claim 16, wherein the transforming step further comprises:
comparing the business-related workload for each of the logical geographic seed areas to identify the one of the logical geographic seed areas having a higher business-related workload than the remaining logical geographic seed areas; and
redefining the identified one of the logical geographic seed areas into a plurality of smaller seed areas, wherein each of the smaller seed areas and the remaining logical geographic seed areas have a substantially balanced business-related workload.

28. The non-transitory computer-readable medium of claim 16, wherein the transforming step further comprises:
comparing the business-related workload for each of the logical geographic seed areas to identify a plurality of the logical geographic seed areas having a higher business-related workload than a threshold; and
redefining the identified plurality of logical geographic seed areas into a plurality of smaller seed areas, wherein each of the smaller seed areas and the remaining logical geographic seed areas have a substantially balanced business-related workload.

29. The non-transitory computer-readable medium of claim 16, wherein
each of the seed points identify an entry or exit point for a respective one of the logical geographic seed areas.

30. The non-transitory computer-readable medium of claim 16, wherein the business-related workload comprises at least one of a service call workload factor, a sales workload factor, or a logistics workload factor.

31. An enhanced computer system that improves a process of balancing a business-related workload where an original geographic area is partitioned into a plurality of logical geographic seed areas, the computer system comprising:
at least one processing unit;
at least one memory storage coupled to the processing unit, the memory storage maintaining GIS code and partitioning code for execution by the processing unit, the memory storage further maintaining at least one set of business-related metric information;
wherein the processing unit, when executing the GIS code maintained on the memory storage, is operative to access GIS data representing the original geographic area from a network accessible storage and store the accessed GIS data on the at least one memory storage; and
wherein the processing unit, when executing the partitioning code maintained on the memory storage, is operative to
receive a request to balance the business-related workload related to the original geographic area, the request generated by a business management system in communication with the processing unit of the computer system,
assemble transport-related burden information associated with the original geographic area,
determine transport-related flow information associated with the original geographic area, the transport-related flow information being related to the assembled transport-related burden information,
generate and store a plurality of data structures in the memory storage, the data structures respectively representing the plurality of logical geographic seed areas based upon a watershed analysis of the transport-related burden information within the original geographic area and the transport-related flow information within the original geographic area, wherein each of the data structures generated comprises a first data element identifying one of the logical geographic seed areas and a second data element identifying one of a plurality of seed points corresponding to a transport interface for the respective one of the logical geographic seed areas,
access the at least one set of business-related metric information maintained within the memory storage,
determine if the business-related workload for each of the logical geographic seed areas is substantially balanced based upon the accessed at least one business-related metric, and
transform at least one of the data structures representing one of the logical geographic seed areas into at least two alternative data structures respectively representing a subdivision of the one of the logical geographic seed areas when the at least one business-related metric reflects an imbalance in the business-related workload for the one of the logical geographic seed areas,
store the at least two alternative data structures within the memory storage, and
transmit the at least the two alternative data structures to the business management system in response to the received request.

32. The computer system of claim 31, wherein the processing unit, when executing the partitioning code, is further operative to generate and store the plurality of data structures by being operative to:
partition the original geographic area into a plurality of units;
combine different types of transport-related burden data to quantify an effort to traverse each of the units, wherein the resulting combined transport-related burden data being a composite transport-related burden value for each of the units within the original geographic area;
determine the transport-related flow information for the original geographic area as (1) a flow direction associated with each of the units, the flow direction being based collectively on the composite transport-related burden information for the unit and surrounding ones of the units relative to the unit, and (2) a flow accumulation associated with each of the units, the flow accumulation for a particular unit being based on how many others of the units collectively direct transport through the particular unit;
identify a plurality of seed points within the original geographic area as those of the units having a designated value for the flow accumulation; and
identify each of the logical geographic seed areas as collectively including those of the units that respectively flow to each of the seed points.

33. The computer system of claim 32, wherein each of the units further comprises one from a group comprising a cell from a plurality of cells representing the original geographic area, a grid element from a plurality of grid elements representing the original geographic area, a designated shape from a plurality of designated shapes representing the original geographic area, or a polygon from a plurality of polygons representing the original geographic area.

34. The computer system of claim 32, wherein the different types of transport-related burden data comprises a first type corresponding to a value for substantially impeded transport and at least one more additional type of transport-related burden data respectively representing one or more types of transportation routes.

35. The computer system of claim 34, wherein the at least one more additional type of transport-related burden data respectively reflects one or more types of geographic features that impact transport.

36. The computer system of claim 35, wherein the at least one more additional type of transport-related burden data respectively comprises data for a portion of the units that represent the original geographic area, the portion being associated with at least one of a service area, a facility location, a military base, a land use type, an interstate highway, a local highway, a local road, a bridge, a tunnel, a ferry, a railroad line, a mountain, a valley, or a body of water.

37. The computer system of claim 32, wherein the at least one more additional type of transport-related burden data further comprises a priority type of the transport-related burden data that overrides one or more of the other types of transport-related burden data.

38. The computer system of claim 31, wherein the at least one set of business-related metric information further comprises business information.

39. The computer system of claim 38, wherein the historic business information further comprises at least one of sales information associated with each of the logical geographic seed areas, service information associated with each of the logical geographic seed areas, and logistics information associated with each of the logical geographic seed areas.

40. The computer system of claim 39, wherein the logistics information further comprises at least one of delivery information, type of logistics server, type of logistics packaging, customer specific logistic information, driving time information, stop time information, driving distance information, a number packages delivered, and a number of packages picked up.

41. The computer system of claim 38, wherein the business information further comprises at least one of a population metric.

42. The computer system of claim 31, wherein the processing unit, when executing the partitioning code, is further operative to transform by being operative to:
compare the business-related workload for each of the logical geographic seed areas to identify the one of the logical geographic seed areas having a higher business-related workload than the remaining logical geographic seed areas; and
redefine the identified one of the logical geographic seed areas into a plurality of smaller seed areas, wherein each of the smaller seed areas and the remaining logical geographic seed areas have a substantially balanced business-related workload.

43. The computer system of claim 31, wherein the processing unit, when executing the partitioning code, is further operative to transform by being operative to:
comparing the business-related workload for each of the logical geographic seed areas to identify a plurality of the logical geographic seed areas having a higher business-related workload than a threshold; and
redefining the identified plurality of logical geographic seed areas into a plurality of smaller seed areas, wherein each of the smaller seed areas and the remaining logical geographic seed areas have a substantially balanced business-related workload.

44. The computer system of claim 31, wherein each of the seed points identify an entry or exit point for a respective one of the logical geographic seed areas.

45. The computer system of claim 31, wherein the business-related workload comprises at least one of a service call workload factor, a sales workload factor, or a logistics workload factor.
